(19) United States
(12) Patent Application Publication
(10) Pub. No.: US 2005/0238771 A1
(43) Pub. Date: Oct. 27, 2005

(54) Process for feeding individual sheeted products to a conveyor with thrusters in an apparatus for packaging publishing products

(75) Inventors: Aris Ballestrazzi, Savignano Sul Panaro (IT); Lamberto Tassi, Modena (IT)

Correspondence Address: HEDMAN & COSTIGAN P.C., 1185 AVENUE OF THE AMERICAS, NEW YORK, NY, 10036, US

(73) Assignee: Sitma S.p.A.

(21) Appl. No.: 11/114,677

(22) Filed: Apr. 25, 2005

(30) Foreign Application Priority Data
Apr. 27, 2004 (IT) MI2004A000833

(51) Int. Cl. A21D 6/00

(52) U.S. Cl. 426/502

(57) ABSTRACT

A process for feeding individual sheeted products to a conveyor (13) with thrusters (14) in an apparatus for packaging publishing products through at least one feeder (11) that comprises a pile (12) of sheeted products (10) in which an individual sheeted product (10) is slipped away from the bottom of the pile (12) and is gripped by a gripping element (18) arranged integral with a rotating disc (19) for feeding it towards the conveyor (13) with thrusters, said process foreseeing the steps of: arranging a pair of rollers (21) downstream of the rotating disc that receive the individual sheeted product (10), and actuating the rollers (21) at a different speed to that at which the conveyor with thrusters advances in at least a portion of the discharge cycle (K) of the individual sheeted product (10) at a different speed to the optimal one. The invention also concerns a feeder (11) that uses such a process.

The present invention refers to a process for feeding individual sheeted products to a conveyor with thrusters in an apparatus for packaging publishing products and to a feeder that uses such a process.

In the field of the selection and transportation of sheeted products, in particular in conveyors with thrusters associated with packaging apparatuses, there can be problems in the correct and aligned feeding of the sheeted products, such as inserts, supplements and publishing products in general. Indeed, these products must usually be fed to the conveyor with thrusters in such a way as to remain perfectly aligned above it, or rather above one or more similar products beneath it brought forwards by the respective thruster.

This is particularly required so as not to create packaging problems and to be able to make the finished package, for example consisting of many products piled up, take up a pleasant and neat appearance, with well-aligned orientation and parallel to what will then become its final position that it must take up.

This correct arrangement of the single or additional sheeted element of the final package on the conveyor with thrusters must be able to be achieved irrespective of the advancing speed thereof, i.e. irrespective of the operating speed of the entire apparatus.

The purpose of the present invention is therefore that of solving such problems, carrying out a feeding of sheeted products towards a conveyor with thrusters, in particular for example associated with a packaging apparatus, which is always perfectly neat and correct.

Another purpose is that of being able to carry out feeding of sheeted products towards a conveyor with thrusters, irrespective of the operating speed of the entire packaging apparatus of the products.

These purposes according to the present invention are accomplished by carrying out a process for feeding individual sheeted products to a conveyor with thrusters in an apparatus for packaging publishing products, and a feeder that uses such a process, according to what is outlined in the independent claims.

Other characteristics emerge from the subsequent attached claims.

The characteristics and advantages of a process for feeding individual sheeted products to a conveyor with thrusters in an apparatus for packaging publishing products, and a feeder that uses such a process according to the present invention shall become clearer from the following description, given as an example and not for limiting purposes, referring to the attached schematic drawings, in which:

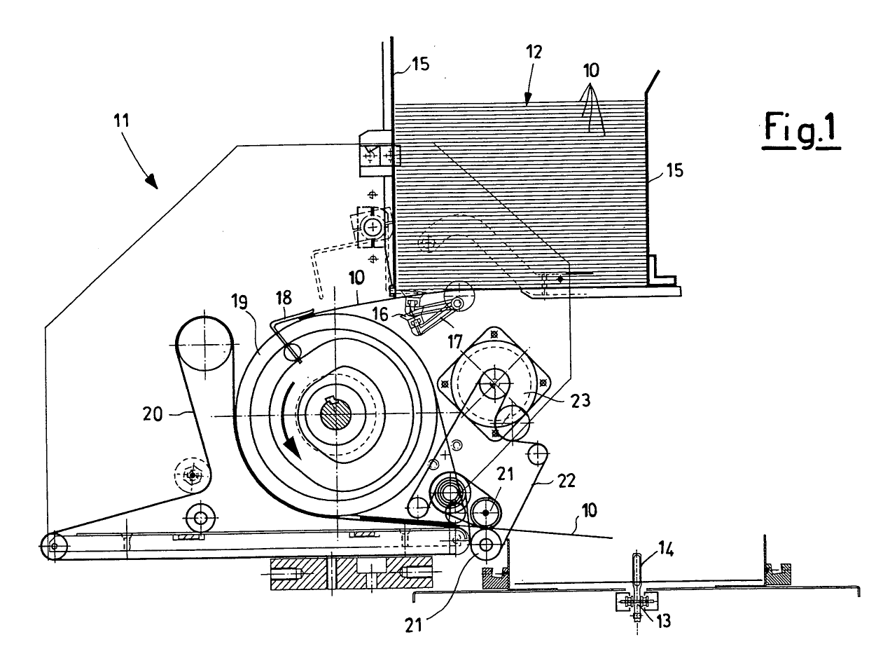

FIG. 1 is a side elevation partial section view of a controlled supply feeder according to the present invention that is transferring the sheeted product on a conveyor with thrusters, shown only partially, and

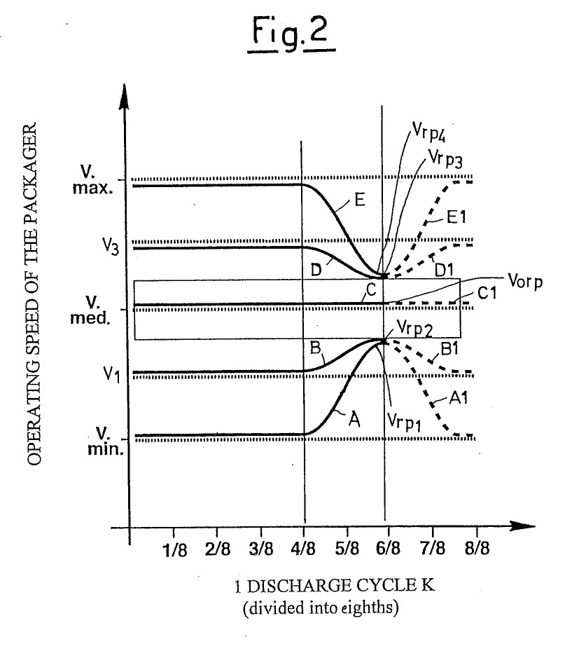

FIG. 2 is a diagram that shows the variations in feeding speed of the sheeted product with respect to the speed of the conveyor with thrusters in an entire discharge cycle, at three different operating speeds of the machine.

In FIG. 1 in general, a feeder or rather a feeding device 11 of individual sheeted products is shown schematically, through which individual sheeted products 10 are withdrawn from the bottom of a pile 12 and are fed towards a conveyor 13 with thrusters 14, in particular associated with a packaging apparatus (not shown).

It is worth remembering, for a better and more immediate understanding of the finding, that the sheeted products 10 are piled up and held by vertical guides 15, which, through suckers 16 lying below (just one of which is shown), allow the last sheeted product 10 at the base of the pile 12 to be picked up and slipped away. In this way an end edge of the sheeted product 10 is slipped away from the bottom of the pile 12 and is gripped by a suitable gripping element arranged integral with a rotating disc that is the actual feeding device towards the conveyor with thrusters. In general, the suckers 16 are arranged on a rocker arm 17 and the gripping element is a pincer 18 associated with a suitable rotating pincer-holding disc 19.

In general, moreover, in collaboration with the pincer-holding disc 19 a band 20 is foreseen that partially winds around the pincer-holding disc 19 and that collaborates to hold the sheeted product 10 in position integral with the pincer-holding disc 19, before being released towards the conveyor 13 with thrusters 14.

According to the finding, it is then foreseen to arrange a pair of rollers 21 one above the other to make a calender for feeding towards the conveyor 13 with thrusters 14. In particular, actually according to the invention these rollers 21 are both connected through a suitable belt transmission 22 to a variable speed motor 23 that is commanded to rotate according to the operating speed of the packaging apparatus.

The invention foresees that there is a special process for feeding individual sheeted products 10 to a conveyor 13 with thrusters 14 in a packaging apparatus, for example of publishing products such as newspapers, magazines, books, envelopes, giveaways or other similar products.

Such feeding is carried out according to the particular requirement of the packaging apparatus. The process is characterised in that the rollers 21 are actuated at a different speed to that at which the conveyor 13 with thrusters 14 advances and to the peripheral speed of the pincer-holding disc 19 in at least a portion of a discharge cycle K of the individual sheeted product 10. This process is actuated when the speed of the packaging machine is a different speed to the optimal operating speed.

In the graph of FIG. 2, as can be seen extremely clearly, along the X-axis the fractions of the discharge cycle K are indicated divided into eighths and along the Y-axis a series of five constant operating speeds of the packager, in other words those of the conveyor with thrusters and those of the rotating pincer-holding disc, is indicated with dotted lines.

Indeed, when the packager or packaging apparatus and consequently the conveyor 13 with thrusters 14 and the pincer-holding disc 19 have a constant low or minimum operating speed Vₘᵢₙ, the rollers 21 of the feeder or feeding device 11, which had a peripheral speed equal to that of the conveyor 13 with thrusters 14 and the pincer-holding disc 19 from ⅛ to 4/8 (indicated with solid line), carry out a great acceleration according to a first half of a certain curve A (in a solid line) reaching a correct release speed of the product Vᵣₚₗ. In such a way they quickly actuate the discharge of the individual sheeted product 10 in the second half of the discharge cycle K for feeding to the conveyor 13 with thrusters 14. More specifically, such an acceleration of the rollers 21 and of the product 10 takes place between 4/8 and 6/8 of the second half of the cycle. Then once the product 10 has been released, the rollers 21 decelerate with a second symmetrical half of curve A1 (in a broken line) until they go back to the same speed as the conveyors with thrusters and the rotating pincer-holding disc.

In order to be able to do this, i.e. to foresee according to the invention a higher speed Vᵣₚₗ of the individual sheeted product 10 and of the rollers 21 as indicated above, the motor 23 accelerates greatly determining a great acceleration of the two rollers 21 and carrying out a quick positioning of the individual sheeted product 10 in front of the thruster 14 in arrival.

When, on the other hand, the conveyor 13 with thrusters 14 and the pincer-holding disc 19 have a speed V₁ between the minimum and the average, the rollers 21 actuate a lower acceleration according to a curve B again to reach a correct release speed Vᵣₚ₂ of the individual sheeted product 10 in the same step between 4/8 and 6/8 of the discharge cycle K to the conveyor 13 with thrusters 14. Then, having discharged the product 10 on the conveyor, also in this case the rollers 21 decelerate with a second symmetrical half of curve B1 until it goes to the same speed as the conveyors with thrusters and the rotating pincer-holding disc.

The graph then also illustrates an example in which the packager and consequently the conveyor 13 with thrusters 14 and the pincer-holding disc 19 have a constant average operating speed V_{med}, and the rollers 21 of the feeder 11 rotate at an optimal product release speed Vₒᵣₚ, a speed that is thus maintained when the general working conditions do not change, as indicated by the straight line C, C1.

The two further examples shown in the graph propose different operating situations in which the operating speeds of the packaging machine and therefore of the conveyor 13 with thrusters 14 and of the pincer-holding disc 19 are higher than the average speed.

In a first example of this condition, the packager or packaging apparatus and consequently the conveyor 13 with thrusters 14 and the pincer-holding disc 19 have a higher operating speed than the constant average one V₃, and the rollers 21, which have a peripheral speed equal to that of the conveyor 13 with thrusters 14 and the pincer-holding disc 19 from ⅛ to 4/8, actuate a certain deceleration according to a first half of a certain curve D reaching a correct product release speed Vᵣₚ₃. Then once the product 10 has been released, the rollers 21 accelerate once again with a second symmetrical half of curve D1 until they go back to the same speed as the conveyors with thrusters and the rotating pincer-holding disc. Regarding this, the motor 23 decelerates determining a deceleration of the two rollers 21 and carrying out a correct positioning of the individual sheeted product 10 in front of the thrusters 14 in arrival and then accelerates and goes back to the current operating speed of the packager V₃.

Finally, for the sake of completeness, an example of high-speed operation of the packager is also shown. In this case the conveyor 13 with thrusters 14 and the pincer-holding disc 19 have a constant high or maximum operating speed Vₘₐₓ, the rollers 21 of the feeder 11, which had a peripheral speed equal to that of the conveyor 13 with thrusters 14 and of the pincer-holding disc 19 from ⅛ to 4/8, carry out a great deceleration according to a first half of a certain curve E between 4/8 and 6/8 of the second half of the cycle, reaching a correct product release speed Vᵣₚ₄. In such a way, they actuate the discharge of the individual sheeted product 10 in the second half of the discharge cycle K for feeding to the conveyor 13 with thrusters 14. Then once the product 10 has been released, the rollers 21 accelerate with a second symmetrical half of curve E1 until they go back to the same speed as the conveyors with thrusters and the rotating pincer-holding disc.

According to this feeding process that adapts to the various operating steps of the packaging apparatus the purposes of the present invention are thus achieved.

Advantageously, there are no sheeted products that are discarded during the feeding step towards the conveyor with thrusters, once slipped away from the pile. It is thus possible to eliminate special devices that hold the products and necessarily convey it in the sliding seat of the conveyor 13 with thrusters 14.

Consequently, according to the present invention it is possible to feed an individual sheeted product towards the conveyor with thrusters in step whether it is carried out at a high operating speed or at a low operating speed.

The process according to the invention is particularly simple in structure and does not require complicated arrangements of constructive parts.

The process of the present invention thus conceived is susceptible to numerous modifications and variants, which are all covered by the invention itself.

Moreover, in practice, the materials used, as well as their sizes and the components of the feeder, can be whatever according to the technical requirements.

1. Process for feeding individual sheeted products to a conveyor (13) with thrusters (14) in an apparatus for packaging publishing products through at least one feeder (11) that comprises a pile (12) of sheeted products (10) in which an individual sheeted product (10) is slipped away from the bottom of the pile (12) and is gripped by a gripping element (18) arranged integral with a rotating disc (19) for feeding it towards the conveyor (13) with thrusters, said process being characterised in that it foresees the steps of: arranging a pair of rollers (21) downstream of said rotating disc that receive the individual sheeted product (10), and actuating said rollers (21) at a different speed to that at which said conveyor with thrusters advances in at least a portion ( 4/8- 6/8) of the discharge cycle (K) of said individual sheeted product (10) at a different speed to the optimal one.

2. Process according to claim 1, characterised in that said rollers (21) are actuated at a higher speed (Vᵣₚ₁, Vᵣₚ₂) than the advancing speed (Vₘᵢₙ, V₁) of said conveyor (13) with thrusters (14) in a portion ( 4/8- 6/8) of a second half of the discharge cycle (K) of said individual sheeted product (10) when said advancing speed of said conveyor with thrusters is low.

3. Process according to claim 1, characterised in that said rollers (21) are actuated at a lower speed (Vᵣₚ₃, Vᵣₚ₄) than the advancing speed (Vₘₐₓ, V₃) of said conveyor (13) with thrusters (14) in a portion ( 4/8- 6/8) of a second half of the discharge cycle (K) of said individual sheeted product (10) when said advancing speed of said conveyor with thrusters is high.

4. Process according to claim 1, characterised in that said rollers (21) are actuated at the same speed (Vₒᵣₚ) as the advancing speed (V_{med}) of said conveyor (13) with thrusters (14) for a safe and correct release of the individual sheeted product (10).

5. Feeder for supplying individual sheeted product to a conveyor (13) with thrusters (14) in a apparatus for packaging publishing products to carry out the process of any one of the previous claims comprising a pile (12) of sheeted products (10) in which an individual sheeted product (10) is slipped away from the bottom of the pile (12) and is gripped by a gripping element (18) arranged integral with a rotating disc (19) for feeding it towards the conveyor (13) with thrusters, characterised in that a pair of rollers (21) is foreseen downstream of said rotating disc that receive the individual sheeted product (10), said rollers (21) being connected through a transmission (22) to a variable speed motor (23) that is commanded to rotate according to the operating speed of the packaging apparatus.
